(19) United States
(12) Patent Application Publication
(10) Pub. No.: US 2026/0295643 A1
(43) Pub. Date: Oct. 1, 2026

(54) CLEANING TOOL FOR A HEARING DEVICE CHARGER

(71) Applicant: SONOVA AG, Stäfa (CH)

(72) Inventors: Maximilian Rose, Stäfa (CH); Nino Scheidegger, Stäfa (CH); Tim Gerbert, Stäfa (CH); Thomas Knoblauch, Stäfa (CH); Tabea Kowalski, Zurich (CH); Monicka Stagliano, Stäfa (CH)

(21) Appl. No.: 19/091,083

(22) Filed: Mar. 26, 2025

(51) Int. Cl. B08B 9/087

(52) U.S. Cl. CPC B08B 9/087; B08B 2209/08

(57) ABSTRACT

A tool for cleaning a charging device of a hearing device includes a base having a front surface and a rear surface, and at least one cleaning member protruding from the front, the at least one cleaning member having an absorbent body soaked in a cleaning liquid. The cleaning tool further includes a handle protruding from the front surface or the rear surface of the base, that is interposed between the first cleaning member and the second cleaning member in a width dimension of the base portion. When inserted into a charging device, the at least one cleaning member is inserted into a hearing device recess of the charging device and the absorbent body makes contact with a charging contact within the hearing device recess, thereby cleaning the contact by mechanical and/or chemical means.

### BACKGROUND

Modern hearing devices, such as hearing aids, are often stored in portable cases. These cases provide the dual functionality of protecting the hearing device and recharging batteries contained within the hearing devices. In some forms, cases may implement recesses for storage of the hearing devices, with each recess having charging contacts that provide power to the hearing devices. Over time, contaminants (e.g., excessive humidity, ear wax, sun cream, contact corrosion and the like) can accumulate on the surface of the hearing device and on the charging contacts, leading to less effective charging. As the charging contacts may be fragile, attempts to clean the contacts using household tools or chemicals can damage the charging contacts further.

### BRIEF SUMMARY

As shown throughout the embodiments of this disclosure, a cleaning tool for a hearing device charger is presented that addresses these problems.

According to one example, a cleaning tool for cleaning charging contacts located in a recess of a charging device, which charging device is configured to charge hearing devices once they are inserted into the recesses, comprises: a base having a front surface; and a cleaning member protruding from the front surface, the cleaning member comprising a deformable absorbent body soaked in a cleaning liquid, wherein the at least one cleaning member extends in a direction transversely to the plane by a length that enables contact between the cleaning member and the charging contacts when inserted into the recess of the charging device, and wherein that the absorbent body is partially deformed when inserted into the charging device and in contact with the charging contacts of the recess.

In various embodiments of the above example, the cleaning tool comprises two cleaning members protruding from the front surface, and a handle protruding from the front surface, wherein the handle is interposed between the first cleaning member and the second cleaning member in a width dimension of the base portion; the absorbent body is a sponge; the cleaning liquid is isopropyl alcohol; the cleaning member is rotatably mounted to the base and/or the absorbent body is rotatably mounted to the cleaning member; the rear surface comprises a coupling element configured to secure the cleaning tool in a lid of the charging device; the coupling element is a releasable form-fit coupling between the lid and the base; the handle protrudes from the rear surface; the at least one cleaning member comprises a rod to which the absorbent body is attached, and the rod is bendable to allow a deflection of the absorbent body relative to the recess when inserting the absorbent body into the recess; at least one of the cleaning members comprises a stop at a predetermined distance from an end of the cleaning member having the absorbent body that is configured to prevent insertion of the cleaning member into the recess of the charging case an amount greater than the predetermined distance; the at least one cleaning member is configured to apply a force that causes elastic deformation, but not plastic deformation, of the charging contacts when inserted in the recess; the absorbent body is deformed by at least a factor of two when inserted into the charging device and in contact with the charging contacts of the recess; a length of the absorbent body in the direction perpendicular to the plane is at least twice a length the charging contacts extend into the recess; the partial deformation of the absorbent body upon insertion into the recess is smaller in dimension than a maximal deflection of the charging contacts in a working range of the charging contacts.

According to another example, a hearing device system comprises: the cleaning tool of claim of any of the above-described examples; and the charging device comprising: the lid, and a housing base having two hearing device recesses, each with charging contacts therein, wherein the cleaning tool further comprises a handle that protrudes from the front surface, wherein the base of the cleaning tool has a same shape as the lid of the charging device, and wherein when the charging device is in a closed state, the base of the cleaning tool fits within the lid and the cleaning member extends into one of the hearing device recess such that the absorbent body makes contact with the corresponding charging contact.

In various embodiments of the above example hearing device system, a size of the absorbent body of the at least one cleaning member is greater than a size of the corresponding hearing device recess; a length of the at least one cleaning member is greater than a length of the corresponding hearing device recess, such that the absorbent body deforms along the length of the at least one cleaning member when the charging device is in the closed state; a diameter of the absorbent body is greater than a diameter of the corresponding hearing device recess, such that the absorbent body deforms in a radial direction when the charging device is in the closed state; the system further comprises: a computing device configured to: determine whether a charging contact of the charging device is soiled, and provide an instruction to a user to clean the charging device using the cleaning tool; and/or the computing device is configured to determine the charging contact is soiled by: measuring an electrical resistance between a charging contact of the charging device and a hearing device housed in the charging device during charging of the hearing device, and determining the electrical resistance is greater than a predetermined threshold.

According to another example or another embodiment of the above example hearing device system, a hearing device system comprises: the cleaning tool of claim of any of the above-described examples; and the charging device comprising: the lid, and a housing base having two hearing device recesses each with charging contacts therein, and an interior space comprising electronics, wherein the charging contacts are sealed in the recess such that the cleaning liquid cannot enter the interior space of the housing base.

### BRIEF DESCRIPTIONS OF THE SEVERAL VIEWS OF THE DRAWINGS

FIG. 1 illustrates an example cleaning tool according to the disclosure.

FIG. 2 illustrates an example cleaning tool according to the disclosure with a charging device, in perspective view.

FIG. 3 illustrates a top view of FIG. 2, illustrating a charging device with a cleaning tool according to the present disclosure therein.

FIG. 4 illustrates a front cutaway view of a charging device in a closed stated including a cleaning tool according to the present disclosure.

FIG. 5 illustrates a side view of an example cleaning tool according to the disclosure and a charging device.

FIG. 6 illustrates an example cleaning tool according to a second embodiment of the present disclosure.

FIG. 7 illustrates a flow chart for using a cleaning tool for a charging device according to the present disclosure.

FIG. 8 is a system schematic for an integrated hearing device according to the present disclosure.

### DETAILED DESCRIPTIONS OF THE DRAWINGS

Considering the aforementioned problems with current portable charging devices, there is a need for a cleaning tool that can be used to thoroughly clean the charging contacts of a hearing device charger without damaging said contacts. Herein, the hearing device may be a hearing aid, earphone, or the like; and a user of the cleaning tool may be a wearer of the hearing device and/or a clinician such as a hearing care professional. Thus a wearer may properly clean the hearing device charger without specialized intervention; and a hearing care professional may also clean the hearing device charger during a clinical appointment, for handicapped patients, or the like.

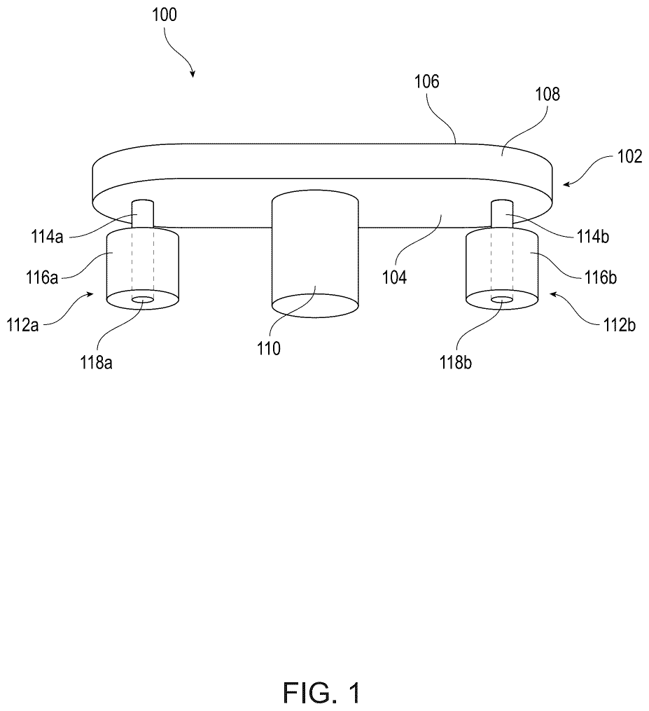

Turning to the figures, FIG. 1 shows an example of a cleaning tool 100 according to the present disclosure. As shown, the cleaning tool 100 has a base portion 102 formed by a front surface 104, a rear surface 106 and a side surface 108. The base portion 102 may be elongated in shape, such that its front surface 104 and rear surface 106 are each a geometric stadium, for example. Other shapes for the base portion 102 may also be suitable, such as an oval, ellipse, rectangle and the like. As will become clear in the proceeding figures, the shape of surfaces 104 and 106 may conform to the shape of a lid of a charger, such that the cleaning tool 100 may be inserted therein. The side surface 108 may be a rectangular shape from a side view but can be formed of other shapes and have a varying thickness. It should also be understood that the surfaces 104, 106 and 108 need not be clearly defined, and other three-dimensional shapes are possible.

The cleaning tool 100 further may have a handle 110 and cleaning members 112a and 112b protruding from the front surface 104 of the base portion 102. As shown, the handle 110 may be a cylinder that may protrude orthogonally, approximately orthogonally, or obliquely from the front surface 104. The handle 110 need not necessarily be a cylinder in shape, as other three-dimensional shapes that protrude from the front surface 104 may be suitable. Further, other types of handles such as hooks, loops, etc. that allow for easy manipulation of the cleaning tool 100 may be alternatively suitable.

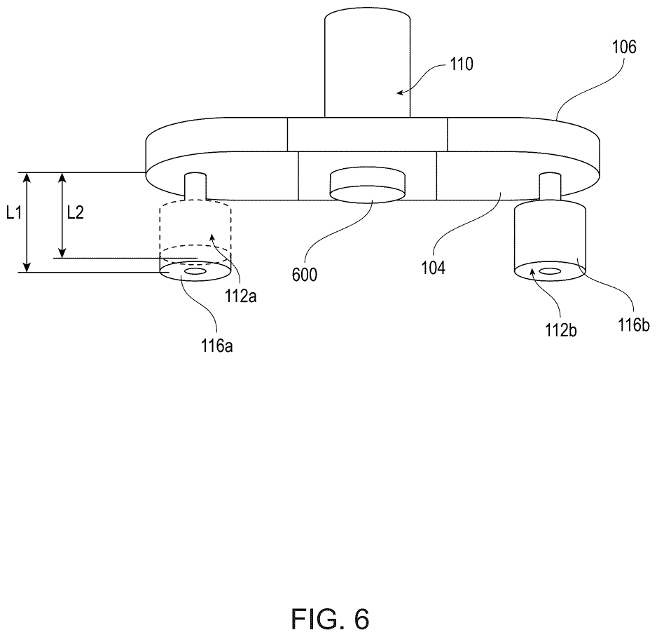

While the handle 110 may be disposed at a variety of locations along the front surface 104, FIG. 1 shows that handle 110 aligned the coaxially with a geometric center, or a center of gravity of the base portion 102. As will be made clear in the proceeding drawings, the length, width and position of the handle 110 may be configured to correspond to the shape of a recess in a charging device, such that the handle can fit inside said recess when a lid of the charging device is closed. The handle may be made of plastic, rubber, or a variety of other rigid materials such that the cleaning tool 100 may be securely handled and positioned into place using only the handle 110. With reference to FIG. 6, and as described in more detail below, the handle 110 may alternatively protrude from the rear surface 106 in other embodiments.

The cleaning tool 100 further has one or more cleaning members 112a and 112b, that likewise may protrude orthogonally from the front surface 104. As discussed in more detail below, the cleaning members 112a and 112b are intended to fit within recesses of a charging device in which a hearing device is normally housed when stored or charged. While a pair of cleaning members 112a and 112b is shown in FIG. 1 respectively near the left and right edges of the base portion 102 on either side of the handle 110, there may be more or fewer cleaning members provided. Further, different arrangements of the cleaning members 112a and 112b relative to the handle 110 and the front surface 104 are contemplated. For purposes of explanation, cleaning members 112a and 112b will be described and shown as identical to each other, but it should be understood that there may be variations between the cleaning members 112a and 112b.

Each of the cleaning members 112a and 112b may have respective cleaning rods 114a and 114b and respective cleaning bodies 116a and 116b. The cleaning bodies 116a and 116b may be formed integrally with the cleaning rods 114a and 114b, or the cleaning bodies 116a and 116b may be separate bodies which may be removably attached to the cleaning rods 114a and 114b. The cleaning rods 114a and 114b may additionally be formed integrally or removably with the base portion 102. The cleaning rods 114a and 114b may additionally be bendable to allow for deflection caused during a cleaning process during insertion and removal in the recesses, as will be described in detail below. The cleaning rods 114a and 114b as shown may be a cylindrical shape, but other longitudinal shapes may be likewise suitable.

The cleaning bodies 116a and 116b should be flexible enough and soft enough not to scratch or damage fragile charging contacts when in use. The cleaning body should also be firm enough to scrub contaminants from said charging contacts. In this regard, the cleaning bodies 116a and 116b may be deformable, meaning that the volume of cleaning bodies 116 and 116b (and/or any other dimension thereof such as height, length or width) may be reduced when compressed by a deformation force. In one particular example, the cleaning bodies 116a are deformable by at least a factor of two.

Further, the cleaning body 116a or 116b may be rotatably mounted to the cleaning rods 114a or 114b, respectively, and/or the cleaning rods 114a, 114b may be rotatably mounted to the base portion 102. Such a configuration allows the cleaning bodies 116a and 116b to rotate with respect to a stationary cleaning rod 114a and 114b, or that the entire cleaning member 112a and 112b rotates such that the cleaning rods 114a and 114b rotate together with the cleaning bodies 116a and 116b on the same axis of rotation. Depending on the embodiment, the cleaning rod 114a or 114b may have a thread with a large lead such that the linear or bow-shaped insertion movement can be converted to rotational movement. The thread may be in the form of a worm gear, for example. It is contemplated that a gear system may be implemented to propel the absorbent cleaning bodies 116a or 116b via an electric motor, hand wheel or other propulsion mechanisms known in the art.

When the bodies 116a and 116b are compressed, the cleaning bodies 116a and 116b consequently exert only an elastic (but not plastic) deformation force on a contacting surface. When the cleaning bodies 116a and 116b are inserted into charging recesses, for example, the contacting surface may be the charging contacts. In some instance, a partial deformation of the cleaning bodies 116a and 116b is less than a maximum deflection of the charging contacts in a working range thereof (i.e., deflection of charging contacts caused by a hearing device inserted into the recess). Such a configuration can allow for abrasive cleaning of the charging contacts without permanently deforming the charging contacts, for example, by weakening their spring constant such that they no longer rest proud of a recesses wall to be contactable by a hearing device in the recess.

Considering the above, the cleaning bodies 116a, 116b can clean charging contacts within a recess of the charging device by force and abrasion of the cleaning bodies 116a, 116b on the charging contacts as the cleaning bodies 116a, 116b are deformed upon contact with the charging contacts and rub against the charging contacts while inserted and removed from the recesses.

The cleaning bodies 116a and 116b may be absorbent bodies made from a sponge, foam, or a variety of other porous materials that can absorb and retain a liquid. It is contemplated that a variety of liquids may be used as the cleaning liquid. For example, common disinfectants such as isopropyl alcohol, ethyl alcohol, soaps, ethanol, antimicrobials, and the like may be effective cleaning liquids. Solutions that evaporate quickly may be preferable substances. Thus, the cleaning bodies 116a and 116b may provide both chemical and mechanical cleaning of the of the charging contacts.

Depending on the embodiment, the cleaning bodies 116a and 116b may be submerged or soaked in the cleaning liquid during a manufacturing stage of the cleaning tool 100. Thus, the cleaning bodies 116a and 116b may absorb the cleaning liquid before packaging and use, and thus may be pre-moistened. The cleaning body 102 may additionally be sealed to prevent evaporation of the cleaning liquid from the cleaning bodies 116a and 116b. A sealant such as a plastic or film wrap (or other like humidity-tight packaging) may be used to enclose the cleaning bodies 116a and 116b. However, in other embodiments, a user may soak the cleaning bodies 116a and 116b in such a liquid. A user may also soak the cleaning bodies 116a and 116b in the cleaning liquid for re-use, even if originally soaked during manufacturing.

In some embodiments, the cleaning tool may be a single-use device that is disposed of after cleaning. But in other embodiments, the cleaning tool may be reusable. For example, the cleaning bodies 116a and 116b may be removably attached to the cleaning rods 114a and 114b, and the cleaning bodies 116a and 116b may each have apertures 118a and 118b formed as a hole which extends coaxially with an axis of the respective cleaning bodies 116a and 116b. In these cases, the cleaning bodies 116a and 116b may be replaced between uses, or re-soaked in a cleaning liquid as discussed above. As shown, the apertures 118a and 118b extend from one surface of the respective cleaning body 116a or 116b all the way to an opposite surface of the cleaning body 116a or 116b, but it is not necessary that the aperture 118a or 118b extends this entire distance.

With such a configuration, the cleaning body may then be removably attached to the respective cleaning rod 114a or 114b by inserting the cleaning rod 114a or 114b into the aperture 118a or 118b of the respective cleaning body 116a or 116b. Accordingly, the aperture 118a or 118b may have a shape and area which corresponds to a cross-sectional area of the cleaning rod 114a or 114b. This may mean that the aperture 118a or 118b has the same area as the cross-sectional area of the cleaning rod 114a or 114b, or that the area of the aperture 118a or 118b is smaller than the cross-sectional area of the cleaning rod 114 and has a flexibility so as to tightly fit over the cleaning rod 114a or 114b. In some embodiments, the cleaning rod 114a or 114b may be excluded and the cleaning body 116a or 116b may form the entire cleaning member 112a or 112b. In such an embodiment, the cleaning body 116a or 116b may be directly attached to, or formed integrally with, the base portion 102.

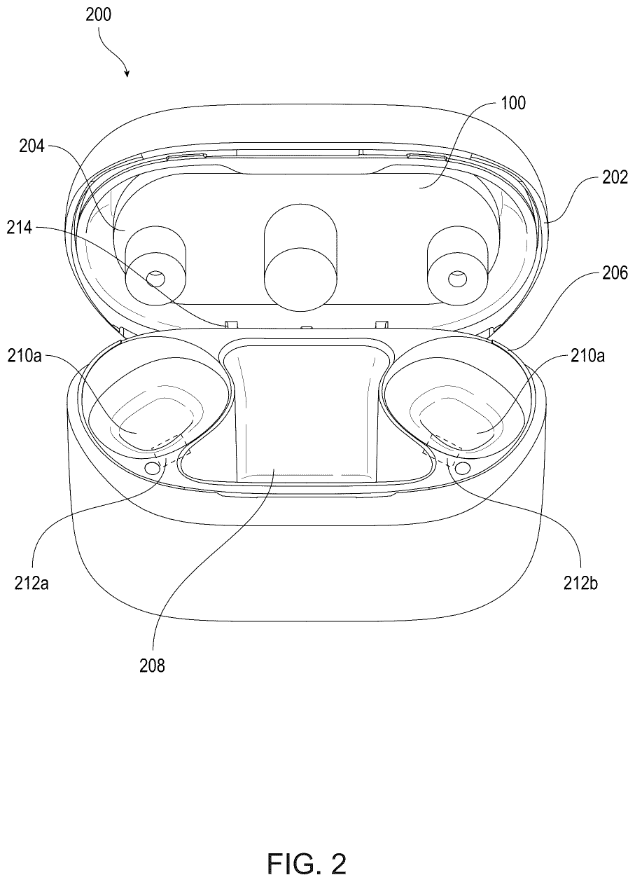

Turning to FIG. 2, the cleaning tool 100 is shown positioned inside a suitable charging device 200, shown in an open configuration. The charging device may have, for example, a lid 202 with a lid recess 204 in which the cleaning tool 100 can be inserted. The charging device 200 may be made of plastic, for example. However, other materials known in the art may be suitable. As shown, the cleaning tool 100 may be formed such that the cleaning body 102 has a shape corresponding to the lid 202 of the charging device 200. For example, both the base portion 102 and the lid 202 of the charging device 200 shown in FIG. 2 have a cross section conforming to a geometric stadium.

The cross-sectional shapes may be understood as two-dimensional shapes of the three-dimensional bodies, for example a top view, bottom view or side view. Thus, cross sectional shapes of the base portion 102 and the lid recess 204 may be configured such that a secure fit is ensured. Additionally, coupling elements such as handles, clips, attachments, and the like may be implemented on any of the surfaces to secure the cleaning device 100 in the lid recess 204 of the charging device 200. For example, a protrusion on a surface of the cleaning device 100 may snap within a hook-like element on the lid recess 204 to secure the cleaning device 100 within the lid 202. In another example, the coupling element may be a releasable form-fit coupling allowing for secure insertion of the base portion 102 into the lid recess 204. Further, adhesives may be applied to the side surface 108 or the rear surface 106 of the base portion 102 to further ensure a secure fit inside the lid recess 204 of the charging device 200. The cleaning device 100 may be formed to fit into a variety of charging devices and may alternatively be designed to be used separately from the lid 202 of the charging device 200, or separately of any charging device.

The charging device 200 further has a charging base portion 206. The charging base portion 206 may include a battery (not shown) that supplies power to charging contacts. This power may may in turn be supplied to hearing devices stored therein by making contact or being in close proximity with the ear buds.

The charging base portion 206 may include a main recess 208 and hearing device recesses 210a and 210b. As shown, the main recess is interposed between the hearing device recesses 210a and 210b. The main recess 208 may be a variety of geometric shapes and may have a depth that extends substantially an entire height of the charging base portion 206. The main recess 208 may have a shape that accommodates the handle 110 of the cleaning tool 100 such that when the charging device 200 is closed, the handle 110 fits in the main recess 208. That is, the main recess 208 may have a cross-sectional area which matches or exceeds a cross-sectional area of the handle 110. Further, the main recess 208 may have a depth that matches or exceeds a length of the handle 110.

The hearing device recesses 210a and 210b are each configured such that respective ear buds may be placed inside for storage and/or charging. As shown, the hearing device recesses 210a and 210b are formed on each side of the main recess 208 and angled obliquely with the width of the charging device 200. The hearing device recesses 210a and 210b are shown to be ovals in shape, but a variety of shapes are possible to accommodate differently shapes hearing devices. The hearing device recesses 210a and 210b may be multileveled such that an inner portion of the recess has a greater depth than an outer portion of the recess.

The hearing device recesses 210a and 210b include respective charging contacts 212a and 212b provided at an interior surface of each of the hearing device recesses 210a and 210b. The charging contacts 212a and 212b may be sealed such that liquid from the absorbent cleaning bodies 116a and 116b does not enter an interior of the charging device 200 and damage internal computing parts such as a PCB and the like. The sealant used to seal the charging contacts may be silicone, for example. However, other sealants known in the art may be suitable.

In some embodiments, the charging contacts may instead be positioned at a bottom of the hearing device recesses 210a and 210b. In such an embodiment, the charging contacts may be cleaned by compression of the cleaning bodies 116a and 116b, as discussed above. In some embodiments, the charging contacts 212a and 212b may be provided at a respective side wall of the hearing device recesses 210a and 210b. The positioning of the charging contacts at a side wall of the hearing device recesses 210a and 210b may allow for a further abrasive cleaning effect to occur when the cleaning members 112a and 112b are inserted into the hearing device recesses 210a and 210b, as discussed above.

The lid 202 and the charging base portion 206 of the charging device 200 may be hingedly attached at a hinge 214, such that the charging device may be opened and closed by pivoting the lid 202 about the hinge 214. Additionally, latching components such as magnets, clips, and the like which may secure a connection between the lid 202 and the charging base portion 206 such that the charging device is securely closed.

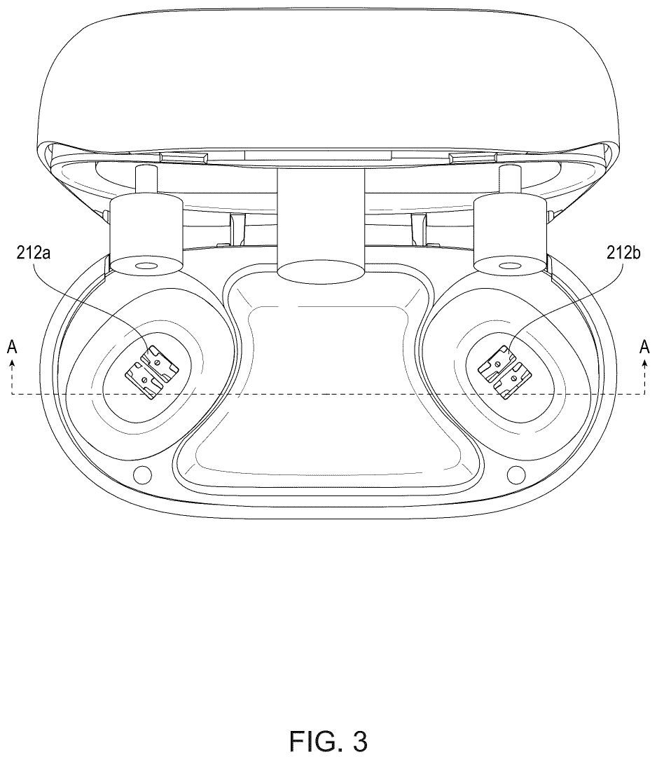

FIG. 3 shows a top view of a charging device 200 with the cleaning tool 100 inserted in the lid 202 thereof. As noted with respect to FIG. 2, the cleaning members 112a and 112b are aligned with charging contacts 212a and 212b such that when the charging device 200 is closed, the cleaning members 112a and 112b contact the charging contacts 212a and 212b. Thus, a cleaning of the charging contacts can be achieved by closing the charging device 200 with the cleaning tool 100 inserted such that the cleaning members 112a and 112b are inserted into the respective hearing device recesses 210a and 210b, rather than the hearing devices.

The charging contacts 212a and 212b are shown as metal pads provided in a lower portion of the hearing device recesses 210a and 210b, and are electrically connected to a battery (not shown) stored in the charging device 200. The charging contacts 212a and 212b may provide an electric current to a hearing device by contact to a corresponding contact surface of the hearing device.

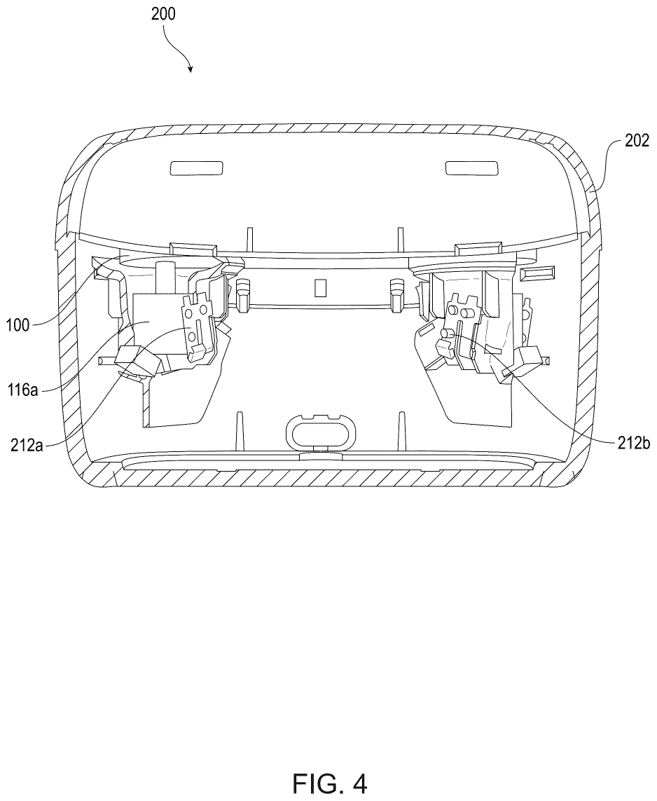

FIG. 4 further illustrates a cutline A-A which spans a width of the charging base portion 206. A cross-section illustration shown in FIG. 4 is obtained by cutting along the A-A cutline. As shown in FIG. 4, the cleaning member 112a is burrowed into the hearing device recesses 210a by closing the lid charging device 200. While only one cleaning member 112a is shown in FIG. 3, it should be understood that a cleaning member 112b may also be provided for hearing device recess 112b.

Here it is noted that the cleaning bodies 116a and 116b may have a size (such as a diameter) greater than that of the hearing device recesses 210a and 210b. When the cleaning bodies 116a and 116b are made of a deformable material such as foam, insertion into the hearing device recesses 210a and 210b causes the cleaning bodies 116a and 116b to compress to the appropriate size and ensure contact with the sides of the hearing device recesses 210a and 210b (and thus the charging contacts 212a and 21b). Further, such deformation of the cleaning bodies 116a and 116b can release cleaning liquid into the hearing device recesses 210a and 210b and onto the charging contacts 212a and 212b. For example, as mentioned above, the cleaning bodies 116a and 116b may be deformable by a factor of at least two.

In this manner, when the charging device 200 is opened and closed in a repeated motion, thorough cleaning can be achieved by wiping the cleaning bodies 116a and 116b (and any cleaning liquid absorbed by the cleaning bodies 116a and 116b) on the respective charging contacts 212a and 212b by the deformation and/or abrasive forces of the cleaning bodies 116a and 116b on the charging contacts 212a and 212b.

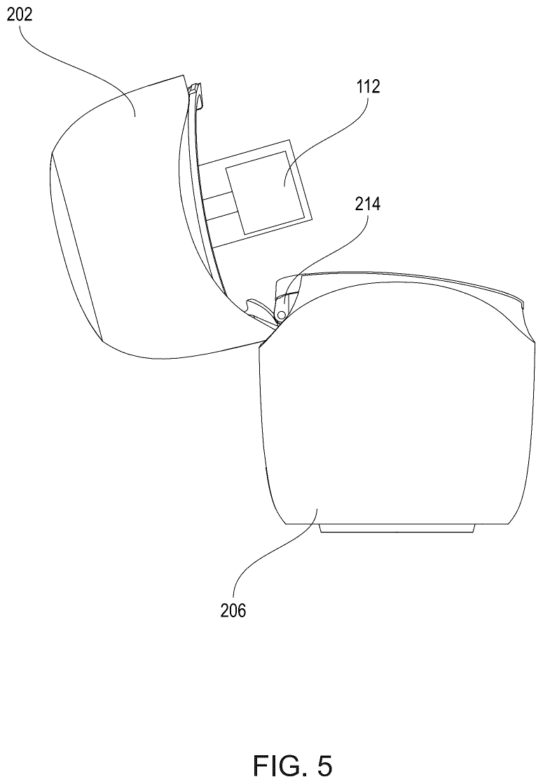

FIG. 5 shows a side view of the charging device 200 in an open configuration with the cleaning members 112a and 112b protruding therefrom. As illustrated in this view, the hinge 214 provides an axis on which a lid 202 of a charging device 200 may be rotated such that the cleaning members 112a and 112b are pulled away from the charging base portion 206. Thus, in use, a user may insert the cleaning tool 100 into the lid 202, and actuate cleaning by repeatedly opening and closing the charging device 200. As suggested above, this motion may be understood as a bowed or curved motion of the cleaning members 112a and 112b. Thus, the bendable structure of the cleaning rods 114a and 114b may accommodate such a motion in that the cleaning rods 114a and 114b allow for deflection when being inserted into and removed from the recesses 210a and 210b.

FIG. 6 illustrates an alternative embodiment of the cleaning tool 100. In this embodiment, the cleaning members 112a and 112b protrude from a front surface 104 of the base portion 102, while the handle 110 protrudes from an opposite rear surface 106 of the base portion 102. It can be appreciated that in this configuration, the handle 110 is still interposed between cleaning members 112a and 112b when viewed from a side, for example. The handle 110 may also be understood as being interposed between the cleaning members 112a and 112b along a width of the base portion 102. Additionally, the cleaning members 112a and 112b may be equidistant from the handle 110.

In such a configuration where the handle 110 is disposed on an opposite surface from the cleaning members 112a and 112b, cleaning may be more easily actuated without fixing the cleaning tool 100 inside a lid recess 204 of a charging device 200. Rather, a user may grip the handle to acuate cleaning by hand. As in the other embodiments already described, any number and type of cleaning members 112a and 112b may be included. In these cases, a stopper 600 may protrude from the front surface 104 (e.g., between the cleaning members 112a and 112b). As shown, the stopper 600 is a body that protrudes from the front surface 104. When the cleaning tool 100 is inserted into the charging device 200, the stopper 600 can abuts a surface of the charging device 200 so that the cleaning bodies 116a and 116b do not extend an excess amount into the hearing device recesses 210a and 210b, thereby preventing damage to the charging contacts 212a and 212b, respectively. While the stopper 600 is shown as a cylindrical body, other geometric shapes may be likewise suitable.

FIG. 6 also illustrates that the cleaning bodies 116a and 116b may be compressible bodies, as already noted. As illustrated, the cleaning bodies 116a and 116b have an uncompressed length of L1 and a compressed length of L2. The lengths L1 and L2 may be measured, in the embodiment shown in FIG. 6, from the front surface 104 to a distal end of the cleaning bodies 116a or 116b; or from a bottom of stopper 600. In one example, the cleaning bodies 116a and 116b can deform a distance (L1−L2) at least twice length of extension of the charging contacts 212a and 212b into the recesses, and exert only an elastic deformation force.

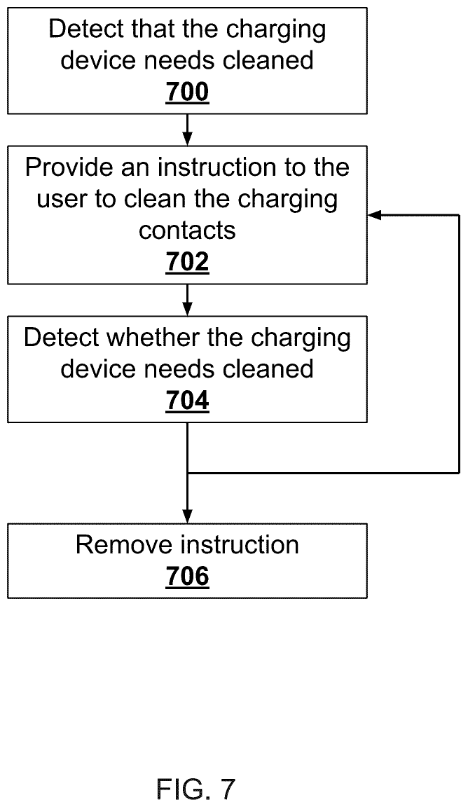

Turning to FIG. 7, a method of sensing and alerting the user that charging contacts of a hearing device is illustrated in the flow chart therein. The method described herein can be used in conjunction with the cleaning tool 100 and the charging device 200, but is not limited to such devices. The hearing device and charging device may individually or both connected to a computing device, such as a smartphone. The computing device may comprise a processor configured to receive data transmitted from the hearing device or charging device, and track metrics relating to the performance of the hearing device and/or charging device.

According to one example, the computing device may be configured to determine a charging efficiency of a charging device delivering an electric current to a hearing device. In this manner, the computing device may determine when charging efficiency has dropped, and then notify the user that the charging device may require cleaning. As shown in FIG. 7, it is first detected that the charging device needs cleaned in step 700. Depending on the embodiment, this determination may be made by sensing electrical properties between the charging device and a hearing device therein during charging. For example, changes in charging voltage or charging current, and/or an increase in electrical resistance may indicate poor contact between the hearing device and the charging contacts. Such poor contact may suggest cleaning is needed.

Once it is determined that the charging device needs cleaning, an instruction may be provided to the user (step 702) notifying the user that the device needs cleaned and instructing the user to clean the charging device. The notification may be provided as a visual instruction on a computing device or may be an audio instruction provided through the hearing device. The notification may include an instruction specifically prompting the user to implement the cleaning tool 100. Here, the notification may identify a specific hearing device recess in which cleaning is needed, or may suggest both recesses need cleaning.

The computing device may continuously determine whether the charging device still needs cleaning (step 704). If, for example, the cleaning of the charging device was successful and the charging efficiency has returned to an acceptable level, the instruction to clean the charging device may be removed or stopped. If it is determined that the charging device has not been cleaned, the instruction to clean the charging device may continue. The notification may also be removed or stopped based on an input from a user indicating that cleaning is complete.

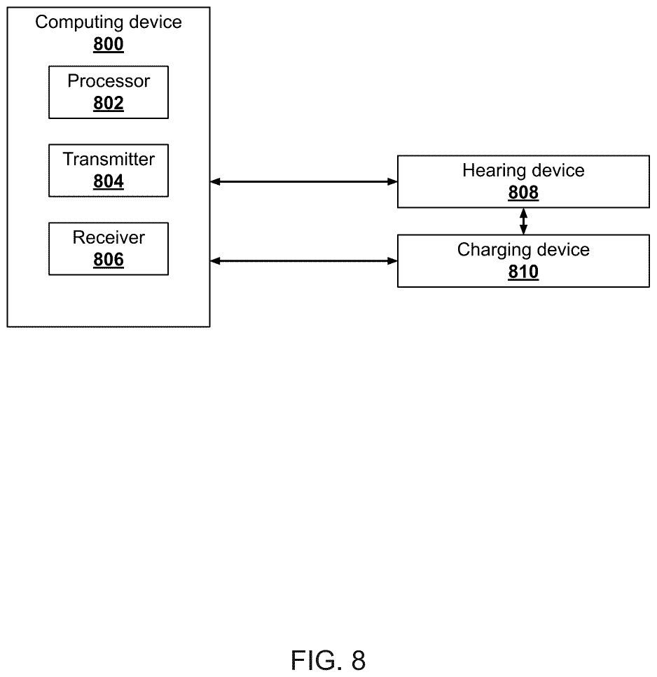

FIG. 8 provides a system diagram of a hearing device system. As shown, a computing device 800 may comprise electronic components such as a processor 802, transmitter 804 and receiver 806. The computing device 800 may be a smartphone, laptop, tablet or the like. Thus, other electronic components known in the art can be comprised therein. The computing device may be in electronic communication with a hearing device 808 and a charging device 810.

While various features are presented above, it should be understood that the features may be used singly or in any combination thereof. Further, it should be understood that variations and modifications may occur to those skilled in the art to which the claimed examples pertain.

1. A cleaning tool for cleaning charging contacts located in a recess of a charging device, which charging device is configured to charge hearing devices once they are inserted into the recesses, the cleaning tool comprising:
a base having a front surface; and
a cleaning member protruding from the front surface, the cleaning member comprising a deformable absorbent body soaked in a cleaning liquid,
wherein the at least one cleaning member extends in a direction transversely to the plane by a length that enables contact between the cleaning member and the charging contacts when inserted into the recess of the charging device, and
wherein that the absorbent body is partially deformed when inserted into the charging device and in contact with the charging contacts of the recess.

2. The cleaning tool of claim 1, comprising:
two cleaning members protruding from the front surface; and
a handle protruding from the front surface,
wherein the handle is interposed between the first cleaning member and the second cleaning member in a width dimension of the base portion.

3. The cleaning tool of claim 1, wherein the absorbent body is a sponge.

4. The cleaning tool of claim 1, wherein the cleaning liquid is isopropyl alcohol.

5. The cleaning tool of claim 1, wherein the cleaning member is rotatably mounted to the base and/or the absorbent body is rotatably mounted to the cleaning member.

6. The cleaning tool of claim 1, wherein the rear surface comprises a coupling element configured to secure the cleaning tool in a lid of the charging device.

7. The cleaning tool of claim 6, wherein the coupling element is a releasable form-fit coupling between the lid and the base.

8. The cleaning tool of claim 1, wherein the handle protrudes from the rear surface.

9. The cleaning tool of claim 1,
wherein the at least one cleaning member comprises a rod to which the absorbent body is attached, and
wherein the rod is bendable to allow a deflection of the absorbent body relative to the recess when inserting the absorbent body into the recess.

10. The cleaning tool of claim 1, wherein at least one of the cleaning members comprises a stop at a predetermined distance from an end of the cleaning member having the absorbent body that is configured to prevent insertion of the cleaning member into the recess of the charging case an amount greater than the predetermined distance.

11. The cleaning tool of claim 1, wherein the at least one cleaning member is configured to apply a force that causes elastic deformation, but not plastic deformation, of the charging contacts when inserted in the recess.

12. The cleaning tool of claim 1, wherein the absorbent body is deformed by at least a factor of two when inserted into the charging device and in contact with the charging contacts of the recess.

13. The cleaning tool of claim 1, wherein a length of the absorbent body in the direction perpendicular to the plane is at least twice a length the charging contacts extend into the recess.

14. The cleaning tool of claim 1, wherein the partial deformation of the absorbent body upon insertion into the recess is smaller in dimension than a maximal deflection of the charging contacts in a working range of the charging contacts.

15. A hearing device system, comprising:
the cleaning tool of claim 1; and
the charging device comprising:
the lid, and
a housing base having two hearing device recesses, each with charging contacts therein,
wherein the cleaning tool further comprises a handle that protrudes from the front surface,
wherein the base of the cleaning tool has a same shape as the lid of the charging device, and
wherein when the charging device is in a closed state, the base of the cleaning tool fits within the lid and the cleaning member extends into one of the hearing device recess such that the absorbent body makes contact with the corresponding charging contact.

16. The system of claim 15, wherein a size of the absorbent body of the at least one cleaning member is greater than a size of the corresponding hearing device recess.

17. The system of claim 16, wherein a length of the at least one cleaning member is greater than a length of the corresponding hearing device recess, such that the absorbent body deforms along the length of the at least one cleaning member when the charging device is in the closed state.

18. The system of claim 16, wherein a diameter of the absorbent body is greater than a diameter of the corresponding hearing device recess, such that the absorbent body deforms in a radial direction when the charging device is in the closed state.

19. The system of claim 15, further comprising:
a computing device configured to:
determine whether a charging contact of the charging device is soiled; and
provide an instruction to a user to clean the charging device using the cleaning tool.

20. The system of claim 19, wherein the computing device is configured to determine the charging contact is soiled by:
measuring an electrical resistance between a charging contact of the charging device and a hearing device housed in the charging device during charging of the hearing device; and
determining the electrical resistance is greater than a predetermined threshold.
